(19) United States
(12) Patent Application Publication
(10) Pub. No.: US 2018/0014171 A1
(43) Pub. Date: Jan. 11, 2018

(54) MANAGEMENT OF EMERGENCY ALERT WAKE UP BITS

(71) Applicant: QUALCOMM Incorporated, San Diego, CA (US)

(72) Inventors: Gordon Kent Walker, Poway, CA (US); Giridhar Mandyam, San Diego, CA (US)

(21) Appl. No.: 15/622,952

(22) Filed: Jun. 14, 2017

Related U.S. Application Data
(60) Provisional application No. 62/368,939, filed on Jul. 29, 2016.
(60) Provisional application No. 62/358,242, filed on Jul. 5, 2016.

(51) Int. Cl. H04W 4/22; H04L 12/18; H04L 29/08

(52) U.S. Cl. CPC H04W 4/22; H04L 12/1895; H04L 69/323

(57) ABSTRACT

Systems and methods are described, which prompt a UE that is receiving at least a physical layer signal from a broadcasting station to look for a new emergency alert. In embodiments, the UE renders content from the broadcasting station based on information received in transmitted physical layer frames. Included within a physical layer frame are bits, such as, ea_wake_up_bits. If the state change of the ea_wake_up_bits indicates that a new emergency message, referencing a new emergency alert, is being transmitted within the physical layer frame, the LTE locates the new emergency message within the physical layer frame and acts on the emergency message if it is applicable to the station to which the UE is tuned. If the emergency message is applicable, the UE acts on the emergency message by using information in the emergency message to locate and render the emergency alert. The emergency message may point to an EAS present on a linear TV service.

### PRIORITY AND RELATED APPLICATIONS STATEMENT

This application claims the benefit of U.S. Provisional Patent Application No. 62/358,242, entitled, MANAGEMENT OF EMERGENCY ALERT WAKE UP BITS”, filed on Jul. 5, 2016, and also claims the benefit of U.S. Provisional Patent Application No. 62/368,939, entitled, MANAGEMENT OF EMERGENCY ALERT WAKE UP BITS”, filed on Jul. 29, 2016, which are expressly incorporated by reference herein in their entirety.

### DESCRIPTION OF THE RELATED ART

Broadcasting services may be used to disseminate emergency alerts to the public. For example, the Emergency Alert System (EAS) is a federally mandated public warning system that requires broadcasters to allow the President to address the nation during a national emergency. EAS may also be used by state and local authorities to distribute pertinent emergency information, such as SILVER alerts, severe weather alerts, AMBER alerts, and the like. Traditionally, when an authorized entity determines that an emergency alert needs to be disseminated to the public, the authority uses the EAS system to generate the emergency alert (e.g., severe weather warning). After the emergency alert is generated, the EAS system broadcasts an emergency alert to all applicable broadcasting stations. For example, a severe weather condition in New York City may cause a severe weather warning to be sent to broadcasters serving the New York City area.

Broadcasting stations (e.g., television stations, radio stations, etc.) are federally mandated to have a device which receives EAS messages, and to monitor the EAS device for incoming EAS alerts. When a broadcasting station receives an EAS alert, the broadcasting station is also obligated to broadcast the EAS alert to the public,

Over time, broadcasting services have evolved. Broadcasts are now transmitted via multiple mediums including the Internet and cellular networks. Further, users are demanding ever increasing resolution (e.g., HD, Ultra HD, etc.) and additional content. Further still, users' viewing habits have changed, such that many services are available on demand as opposed to being regularly scheduled programming. To support these changes, advanced transmission and coding techniques have been developed to increase the amount of data transmitted in a broadcasting spectrum that is becoming increasingly scarce. For example, multiple broadcasting stations can now transmit data on a single 6 MHz RF channel.

Given the recent changes in transmission and coding techniques, broadcasting emergency alerts to the public has become difficult. As such, systems and methods which allow emergency alerts to be disseminated to the public in light of the new transmission and coding techniques are desirable.

### SUMMARY

Systems and methods prompt end user (UE) devices to locate and act upon one or more emergency alert. In an example, a UE is rendering the content of a station (e.g., displaying a TV show). In order for the UE to render the station's content, the UE receives the station's content from a transmitted physical layer frame, which may also include other data from the station and other stations. While the UE is rendering the content of a station, a new emergency alert is issued for the station. The station is notified about the emergency alert when the station receives an emergency message comprising information about the emergency alert,

The physical layer frame upon which the UE receives the station content also includes bits, which collectively indicate to the UE whether the physical layer frame includes an emergency message associated with one of the stations having data in the physical layer frame. If the bits change state on this physical layer frame to a value that indicates the presence of an active emergency message within the physical layer frame, the UE reads the physical layer frame to determine whether the new emergency message is associated with the station to which the UE is tuned. If the UE is tuned to the station associated with the new emergency message, the UE acts on the new emergency message by doing what the new emergency message tells the UE to do. For example, the new emergency message may include information telling the UE to look for an emergency alert and render the emergency alert, in this example, when the emergency alert is found, the UE renders the emergency alert such that it is perceived by the user, according to the instructions in the emergency message.

Prior to the UE receiving the physical layer fame, a system generates the physical layer frame. When generating the physical layer frame, the system determines whether at least one station, of the set of stations including data within the physical layer frame, has an emergency message in its queue. If none of the stations transmitting data on the physical layer frame have a queued emergency message, the system sets the state of the bits to collectively indicate that no new emergency messages are included in the physical layer frame. In contrast, if at least one of the stations has a queued new emergency message, then the system indicates as such by advancing the state of the bits. The bits may be included within the bootstrap or system sync of the physical layer frame. Further, the system at least starts delivery of the emergency message itself within a Low Level Signal (LLS) of the physical layer frame. Further still, the system may include an LLS flag within the preamble of the physical layer frame to indicate which Physical Layer Pipes (PLP)s of a set of PLPs includes one or more LLS. After incorporating other information into the physical layer frame (such as but not limited to content, maps, service definitions, media objects, initialization segments, etc.), the physical layer frame is completed and transmitted to one or more UE.

### BRIEF DESCRIPTION OF THE DRAWINGS

FIG. 1 illustrates an example networked system operable to carry out embodiments described herein.

FIG. 2 illustrates an example physical layer frame as is described herein.

FIG. 3 illustrates an example method, which notifies one or more receiver about one or more emergency alert.

FIG. 4 illustrates an example method, which prompts one or more receiver to look for an emergency alert.

FIG. 5A illustrates an example scheme for advancing the state of ea_wake_up_bits.

FIG. 5B illustrates another example scheme for advancing the state of ea_wake_up_bits.

FIG. 5C illustrates another example scheme for advancing the state of ea_wake_up_bits.

FIG. 6A illustrates an example method of transmitting and receiving a physical layer frame, wherein a plurality of stations included data within the physical layer frame.

FIG. 6B illustrates an example call flow in embodiments wherein the physical layer frame includes a single new emergency message.

FIG. 7 illustrates an example method of transmitting and receiving a physical layer frame, wherein only one station is transmitting data within the physical layer frame.

### DETAILED DESCRIPTION

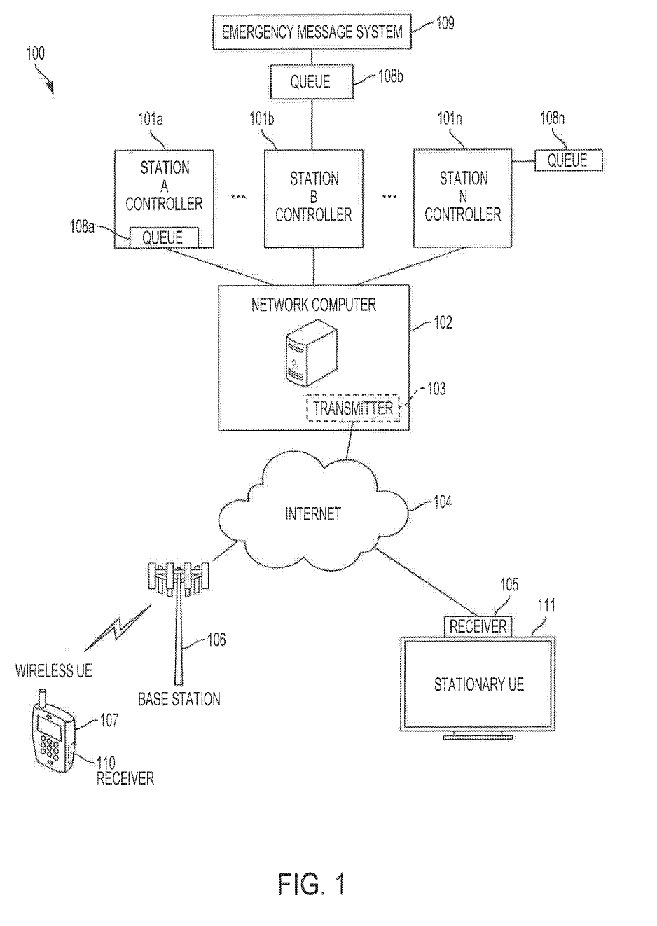

FIG. 1 illustrates an example networked system 100 operable to carry out embodiments described herein. In embodiments, the system is an Advanced Television Systems Committee (ATSC) 3.0 system, which distributes multimedia to stationary and mobile UEs. For example, the system may broadcast, or otherwise transmit, television station content, cable station content, channel menu content, radio station content, on demand content, pay per view content, movie content, video content, audio content, processing data, and the like. The system includes network computer 102, which may be a server, a group of servers, a general purpose processor, a group of general purpose processors, any combination thereof, and/or the like. Network computer 102 may comprise one or more processor, one or more non-transitory memory comprising one or more set of program code, one or more receiver, and one or more transmitter. Further, network computer 102 may be coupled, via the internet 104 or otherwise, to one or more memory comprising one or more set of program code, one or more receiver, and one or more transmitter.

Network computer 102 may be coupled to one or more station controller, for example, station A controller 101a, station B controller 101b, and station N controller 101n. In embodiments, one or more of the station controllers may be housed within network computer 102. In embodiments, one or more of the station controllers may be coupled to network computer 102 via the internet 104, via a WAN, a LAN, dedicated fiber, sight microwave radio, or other means of communication. A station controller may be a server, a group of servers, a general purpose processor, a group of general purpose processors, any combination thereof and/or the like. A station controller may comprise one or more processor, one or more non-transitory memory comprising one or more set of program code, one or more receiver, and one or more transmitter. Further, a station controller may be coupled, via the internet 104 or otherwise, to one or more memory comprising one or more set of program code, one or more receiver, and one or more transmitter.

A station controller controls at least some of the operations for a station and the station's services. For example, station A controller controls at least some of the operations for station A and may control at least some of the operations for one or more of station A's services. For instance, station A may be the Disney Channel (a station that can be broadcasted via cable television), while station A's services may include Disney XD, Disney Junior, etc. In another instance, station B may be CNN (Cable News Network), while station B's services may include CNN Newssource, CNN Money, etc. In embodiments, station A controller 101a may control some or all of the operations of the Disney Channel, Disney XD, Disney Junior, etc., while station B controller 101b may control some or all operations of CNN, CNN Newssource, CNN Money, etc.

Among the operations that one or more of the station controllers may control is managing some or all the station's emergency messages. An emergency message may indicate the existence of an emergency alert. When an emergency event occurs, an emergency service and/or agency may issue an emergency alert which disseminates pertinent information to the public. When an emergency alert goes active, stations that are associated with the active emergency alert will receive a new emergency message indicating that an emergency alert has gone active. As will be further explained below, the emergency message comprises information about the emergency alert and may tell the station and/or a UE tuned to the station how to access the emergency alert or otherwise respond to the situation.

One or more emergency message may be generated by a station or a service. Additionally or alternatively, an emergency message may be generated by emergency message system 109, which may be a third party system such as the Emergency Alert System (RAS), Integrated Public Alert and Warning System (IPAWS), a Federal Emergency Management Agency (FEMA) system, the National Weather Service (NWS) system, EU-Alert system of Europe, National Alert system of Israel, LAT-Alert system of Chile, Earthquake Tsunami Warning System of Japan, any combination thereof, and/or the like.

Emergency message system 109 may be a server, a group of servers, a general purpose processor, a group of general purpose processors, any combination thereof, and/or the like. Emergency message system 109 may comprise one or more processor, one or more non-transitory memory comprising one or more set of program code, one or more receiver, and one or more transmitter. Further, emergency message system 109 may be coupled, via the internet 104 or otherwise, to one or more memory comprising one or more set of program code, one or more receiver, and one or more transmitter, Emergency message system 109 may generate an emergency message according to EAS protocol, Common Alerting Protocol (CAP), AEA MF protocol, EU-Alert protocol, National Alert protocol, Earthquake Tsunami Warning System protocol, and/or the like.

Station controllers may be communicatively coupled to one or more emergency message system 109, for example, via the internet 104, a WAN, a LAN, dedicated fiber, sight microwave radio, or other means of communication. For example, station A controller 101a may receive an emergency message from emergency message system 109 notifying station A controller 101a that an EAS message, CAP message, AEA MF, or the like, is active for station A and/or its services. The emergency message may indicate which station and/or which services of the station are to transmit the emergency message. Upon station A controller 101a receiving the emergency message, the new emergency message may be queued in station A's emergency alert queue 108a. A station's emergency alert queue may be stored within the station controller; for example, emergency alert queue 108a is located within station A controller 101a. Alternatively, the station's emergency alert queue may be located outside the station controller; for example, emergency alert queue 108b is located outside station B controller 101b, is communicably coupled to station B controller 101b, and is communicably between emergency message system 109 and station B controller 101b. In another example, emergency alert queue 108n is located outside station N controller 101n and is communicably coupled to station N controller 10111, wherein station N controller 10111 is communicably between emergency message system 109 and emergency alert queue 108n.

A station's emergency alert queue may queue a plurality of emergency messages if and when multiple emergency alerts go active within a time frame. For example, station A may receive an emergency message referencing an active emergency alert for a tornado warning, an emergency message for a flash flood warning, and an emergency message for a terrorist attack all within the same time period. If more than one emergency message is received within the same time period, the emergency messages may be prioritized within the queue. In embodiments, EAS messages are prioritized higher than non-EAS messages, in embodiments, an emergency message may indicate its priority level, and emergency messages having a higher priority level are prioritized higher than emergency messages having a comparatively lower priority level. If two or snore emergency messages have the same priority level, the emergency messages may be queued in the order in which they were received by the station (e.g., First-In-First-Out).

Network computer 102 may comprise one or more transmitter 103. Additionally and/or alternatively, network computer 102 may be communicably coupled to one or more transmitter 103 via the internet 104 or otherwise. In embodiments, network computer 102 includes one or more emergency message within one or more physical layer frame and uses one or more transmitter 103 to transmit the one or more physical layer frames (and/or other frames) to one or more end user (EU) device (107, 111) via one or more receiver (110, 105). Transmitter 103 may communicate with UE (107, 111) or receiver (110, 105) via internet 104, a WAN, a LAN, dedicated fiber, sight microwave radio, or other means of communication.

UE 111 may be a stationary multimedia device 111, which is connected to a stationary receiver 105. Examples of UE 111 may include a television, a smart television, a desktop computer, a multimedia projector, and the like. Receiver 105 may be incorporated into UE 111, for example a smart television. Receiver 105 may be external from and communicably coupled with UE 111. Examples of an external receiver 105 include a set top box, a set top unit, a cable box, a streaming box (such as, a smart Blu-Ray, a smart DVD player, an Apple TV, a Roku, an Amazon Fire TV Stick, a Chromecast dongle, a Netgear NeoTV, and the like), a gaming system (such as an Xbox, PlayStation, Wii, and the like), and the like.

UE 107 may be a mobile multimedia device, which is connected to a mobile receiver 110, Examples of UE 107 may include a cell phone, smart phone, tablet, smart camera, smart watch, smart glasses, lap top, mobile computer, mobile televisions, and the like. Receiver 110 may be may be incorporated into UE 107, for example a smart phone. Receiver 110 may be external from and communicably coupled with UE 107, for example a smart watch. UE 107 and/or receiver 110 may communicate with network computer 102 wirelessly via one or more base station 106 (and/or one or more femtocell and the like) according to various wireless communication networks such as CDMA, TDMA, FDMA, OFDMA, SC-FDMA and other networks. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2).

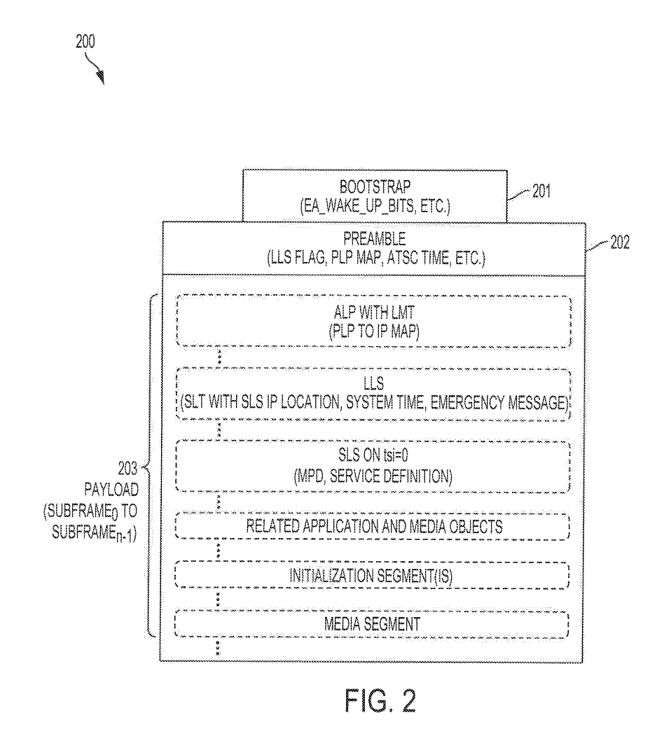

FIG. 2 illustrates an example physical layer frame comprising data, which may be rendered or otherwise processed by a UE. When a user is watching media on a UE, for example watching a television show on UE 107, receiver 110 receives the media content (e.g., the television show) from physical layer frames being transmitted by network computer 102 via transmitter 103. In addition to the media content, the physical layer frame transmits additional data, for example, synching information, timing information, emergency messages, and more.

In embodiments, physical layer frame 200 includes data from only one station. Alternatively, physical layer frame 200 may include data from more than one station. Data from multiple stations may be multiplexed and included in physical layer frame 200 according to any known multiplexing scheme, including but not limited to, OFDM, SDM, PMP, CDMA, Dynamic TDM, FHSS, DSSS, OFDMA, SC-FDM, MC-SS.

Physical layer frame 200 highlights an example structure of an example physical layer frame. Physical layer frame 200 includes bootstrap (or system sync) 201, which may include information about synchronization, system bandwidth, and/or the frame version. Bootstrap 201 may also include an indicator that alerts the UE of the existence of an active emergency alert, which may cause the UE to wake-up and look for the emergency alert. An example of this indicator is a plurality of bits, such as, ea_wake_up_bits. In further detail, the ea_wake_up_bits may comprise two bits, wherein the bits' value identifies the state of the ea_wake_up_bits. The two bits represent a total of four states. The ea_wake_up_bits's state may indicate whether an emergency alert of one of the stations of the frame is active. Further, the ea_wake_up_bits's state may indicate whether a new emergency message is included in the frame. In alternative embodiments, the ea_wake_up_bits need not be included in the bootstrap and could be included in any portion of a frame (e.g., preamble, payload, etc.).

Physical layer frame 200 also includes preamble 202. Preamble 202 may include Physical Layer Pipe (PLP) mapping information, ATSC timing information, modulation information, Fast Fourier Transform (FFT) size, guard interval, interleaving, pilot information, Forward Error Correction (FEC), and the like. Preamble 202 may also include an LLS flag. An LLS flag identifies which PLP or PLPs contain at least one Low Level Signal (LLS). When a UE reads the preamble, the LE will know where to go to find an LLS.

Payload 203 may comprise one or more LLS included within one or more PLP, In embodiments, there is an associated with the occurrence with every frame that is a Random Access Point (RAP). The LLS comprises low level signaling information. Examples of information that may be signaled in an LLS include Service List Table (SLT) information, Service Layer Signaling IP location information, and system time information.

An emergency message may also be included in an LLS. In such cases, the emergency message on the LLS may include the identity of the station transmitting the emergency message and information directing a UE to the emergency alert associated with the emergency message. The emergency message on the LLS may identify the station by including the station's Provider_ID. Because multiple stations may be transmitting data on physical layer frame 200, multiple LLSs may include emergency messages. For example, if station A, station B, and station N are all transmitting on physical layer frame 200 and all have an active emergency alert that is applicable to them, physical layer frame 200 may comprise at least three LLSs having an emergency message: an LLS having an emergency message identifying station A and referencing station A's emergency alert, an LLS having an emergency message identifying station B and referencing station B's emergency alert, and an LIS having an emergency message identifying station N and referencing station N's emergency alert.

Payload 203 may include other information as well, including but not limited to ATSC Link-Layer Protocol (ALP) information, Service Layer Signaling (SLS) information, Application and Media Objects, Initialization Segment information, media segments, and the like.

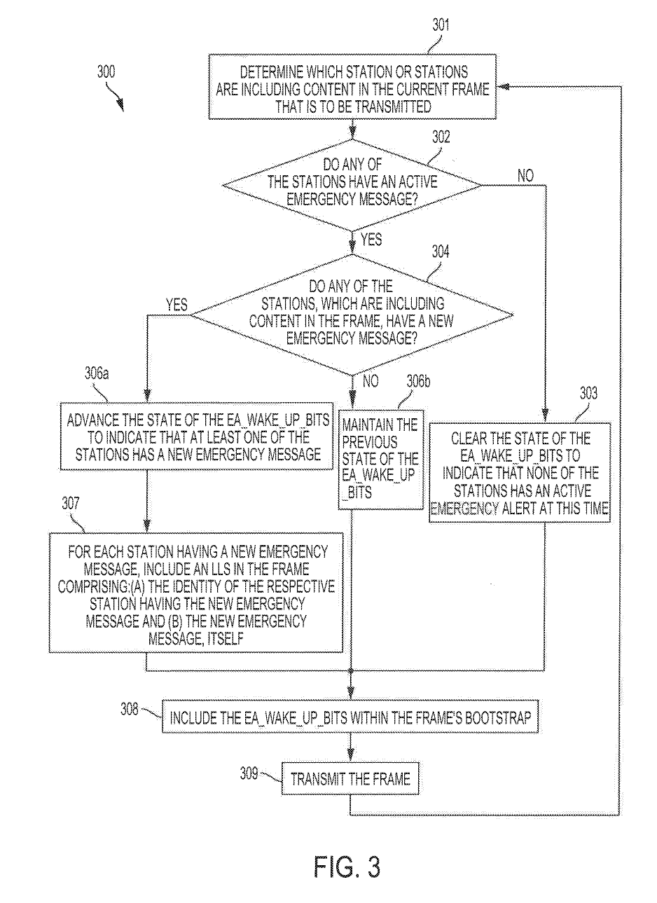

FIG. 3 illustrates an example method 300 of notifying one or more receiver that a new emergency alert went active. The systems and devices of FIG. 1 are operable to perform the steps of method 300. In step 301, the system determines which station or stations are including data in a physical layer frame, which is to be transmitted. In step 302, the system determines whether any of the stations that are including data in the physical layer frame has an emergency message to include in the frame. If the determination of 302 decides that none of the stations have an emergency message to include in the frame, the method moves to step 303 wherein the system ensures that the state of ea_wake_up_bits indicates as such (e.g., the bits value is set at 00). If the ea_wake_up_bits were 00 in the previous frame, then the system may simply maintain the same state. If the ea_wake_up_bits were not 00 in the previous frame, the system may clear the bits such that the bits value is 00 in the present physical layer frame. Thereafter, the system moves to step 308, which will discussed in more detail below.

If, however, at step 302, the system determines that at least one of the stations is including an emergency message within the frame, the system moves to step 304. In step 304, the system determines whether any of the emergency messages to be included in the frame reference a new emergency alert (e.g., an emergency alert that has not yet been referenced in an emergency message of a previous physical layer frame). The system may look at the emergency alert queue of the stations to determine whether an emergency alert is new or not. If none of the emergency messages to be included in the frame reference a new emergency alert, then all the emergency messages to be included in the frame are referencing an active emergency alert, which has previously been indicated in an emergency message. In such a case, the system moves to step 306b which maintains the same state for the ea_wake_up_bits as compared to the previous system layer frame, and the system moves to step 308, which will be discussed in more detail later.

if in step 304 the system determines that at least one of the emergency messages to be included in the frame reference a new emergency alert (e.g., an active emergency alert that will be referenced in art emergency message for the first time), the system moves to step 306a. In step 306a, the system advances, or otherwise changes, the state of the ea_wake_up_bits to indicate that one or more of the stations are including a new emergency message in the physical layer frame. For example, if the ea_wake_up_bits' value was 01 in the previous physical layer frame, the system may advance the ea_wake_up_bits's value to 10.

In step 307, which may occur before or after steps 306a or 306b, the system creates LLSs comprising emergency messages, which may include one or more previously sent active emergency message, one or more new emergency message, and/or any combination thereof. In embodiments, for each station having a new and/or active emergency message, the system generates and includes within the physical layer frame an LLS that may comprise the actual emergency message and the Provider_ID. If more than one station is transmitting an emergency message in the current physical layer frame, and/or if a station is transmitting more than one emergency message, then the system generates more than one LLS that comprises an emergency message, wherein an LLS is generated for each and every emergency message in the current physical layer frame,

At step 308, which may occur at any time after the state of ea_wake_up_bits is established, the ea_wake_up_bits are included in the bootstrap (and/or system sync) of the physical layer frame. Further, at any point after one or more LLS is generated, the one or more LLS is included in the physical layer frame. Further still, at any point after the system determines which LLSs will be included in the physical layer frame, the system includes an LLS flag for the LLSs within the preamble of the physical layer frame.

At step 309, at any time after the physical layer frame is complete, the system transmits the physical layer frame. System 100 is an example system operable to perform the steps of method 300. For example, network computer 102 may perform all of method steps 300. Further, in embodiments, transmitter 103 may perform step 309.

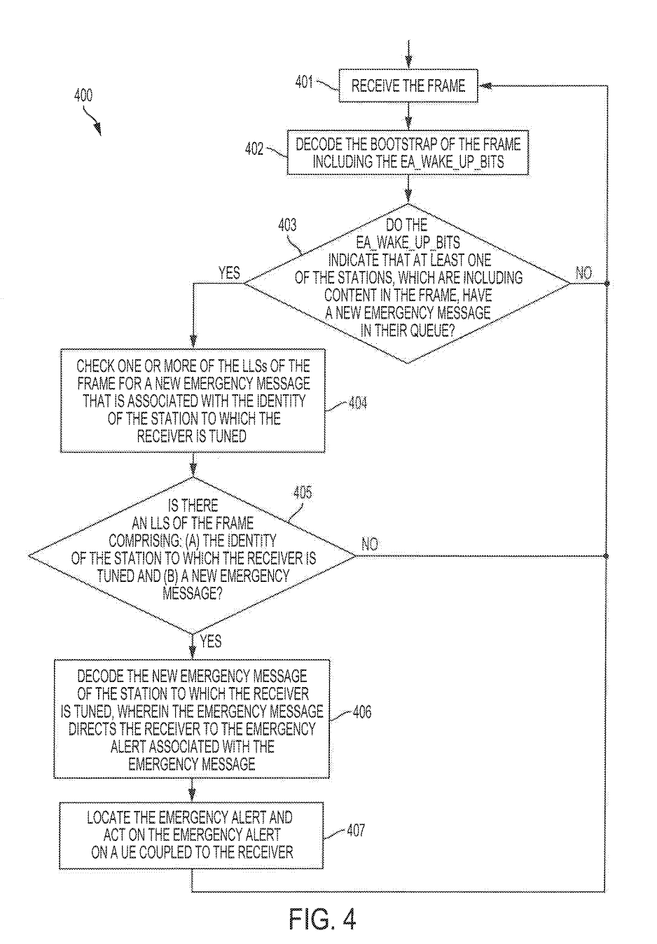

FIG. 4 illustrates an example method, which may prompt one or more receiver to look for an emergency alert. The systems and devices of FIG. 1 are operable to perform the steps of method 400. In step 401, a physical layer frame is received, for example the physical layer frame that was transmitted in step 309 of FIG. 3. In embodiments, a UE has the option of receiving portions of the physical layer frame and ignoring the rest of the physical layer frame. For example, the receiver may choose to receive the bootstrap and ignore the rest of the frame. In other embodiments, the receiver may choose to receive the bootstrap and/or preamble, while ignoring the rest of the frame.

In step 402, the bootstrap (and/or system sync) of the physical layer frame is decoded including the ea_wake_up_bits. With the ea_wake_up_bits decoded, the method moves to step 403, wherein the system determines whether the state of ea_wake_up_bits indicates that a new emergency alert is included in the physical layer frame. If the state of the ea_wake_up_bits indicates that no new emergency alerts are included in the physical layer frame, then the system will not expect a new emergency message to be included in the frame. As such, the system may continue to process the physical layer frame in order to retrieve additional data (e.g. content), but may not take steps directed to locating an LLS comprising a new emergency message.

If in step 403, the system determines that the state of the ea_wake_up_bits indicates that one or more new emergency message is included in the physical layer frame, then the system attempts to locate the new emergency message that is applicable. The system may decode the preamble and read an LLS flag that identifies which PLP car PLPs contain at least one Low Level Signal (LLS). In step 404, the system checks one or more LLSs of the physical layer frame to determine whether any of the LLSs include a new emergency message that is applicable to the UE. A new emergency message will be applicable to the UE if the UE is tuned to the station that sent the new emergency message.

In step 405, the system determines whether any of the LLSs in the physical layer frame comprises the identity of the station to which the UE is tuned (e.g., as indicated by a Provider JD) and a new emergency message. If one or more of the LLSs include a new emergency message applicable to the particular UE, then at step 406, the UE reads (e.g., decodes) the emergency message.

The new emergency message may include information (e.g., <resource>) that directs the UE and/or receiver to a location of the new emergency alert referenced in the new emergency message. Some examples of information that directs the UE to a location of the new emergency alert include, by are not limited to, a Uniform Resource Identifier (URI), a Uniform Resource Location (URL), a Uniform Resource Name (URN), a pointer to a location within the UE, a pointer to a location within the system, a pointer to a location outside the system, a pointer to a location in Emergency Message System 109, any of which may be accessible via the internet, a cellular network, a WAN, and LAN, dedicated fiber, line of sight microwave radio, or otherwise. In embodiments, the new emergency message points to an active streaming media Service (e.g., linear TV channel). Such a media Service may be expressed in the <resource> by @globalServiceID URIs, in examples, the new emergency message (e.g., AEA MF) may include a resource indicator (e.g., <resource>), a. station origination indicator (e.g., Provider_ID), an effectiveness indicator (e.g., <effective>), a power on indicator (e.g., <TVon>, or <UEon>), and/or an expiration indicator (e.g., <expires>). A new emergency alert may also take the form of a text message, a burn in, streaming video, a banner, any combination thereof, and/or the like. In embodiments, one or more of the indicators give instructions to the UE. For example, if <TVon> (or <UEon>) is set to 1, then the TV (or UE) is instructed to turn on for the duration of the alert. If <TVon> (or <UEon>) is set to 0, then the TV (or UE) is not instructed to turn on for the duration of the alert. If the UE is instructed to turn on for the duration of the emergency alert, the user may have the option of turning the UE off such that the UE does not turn back on for the emergency alert.

In step 407, the UE acts upon the new emergency message by executing the operations indicated in the emergency message. In short, the UE does what the new emergency message tells the UE to do. For example, the UE acts upon the new emergency message by using the included information to locate the new emergency alert. If the UE is instructed to renderer the new emergency alert (e.g., display the emergency alert on a display of the UE), then the UE renders the new emergency alert as directed. For example, the UE may display content front a linear TV channel broadcasting the emergency alert. Further, the system may continue to process the physical layer frame in order to retrieve additional data and/or receive the next physical layer frame. System 100 is an example system operable to perform the steps of method. 400. For example, UE (107, 111) and/or receiver (110, 105) may perform some or all of method 400.

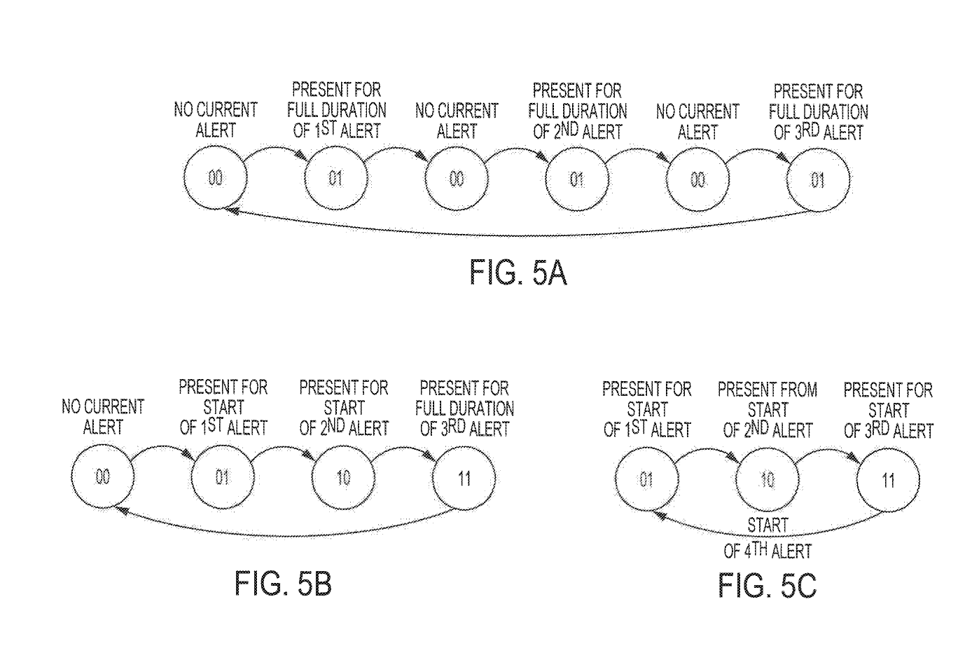

FIG. 5A illustrates an example scheme for advancing (or otherwise changing) the state of ea_wake_up_bits, as was discussed in steps 303, 306a, and 306b of FIG. 3. As will be explained, the value of the ea_wake_up_bits may indicate that no emergency messages are included in the current frame. Further, the advancement (or change) of the ea_wake_up_bits may indicate that a new emergency message is starting transmission in the current frame. Further still, the value of the ea_wake_up_bits may indicate that within the current frame is one or more active emergency message that was included in a previous frame.

In embodiments, the delimit state of the ea_wake_up_bits indicates that no emergency message is included in the physical layer frame. This default state may be identified by the bits value being 00. When a physical layer frame is generated that will include a new emergency message, the state of the ea_wake_up_bits may be advanced (e.g., changed), such that the bits value is 01. Because the value of the bits include a “1,” the ea_wake_up_bits indicate the presence of an active emergency message within the present frame. Further, advancing (e.g., or otherwise changing) the state of the ea_wake_up_bits in this frame, as compared to the ea_wake_up_bits of the previous frame, to a value that includes a “1” indicates that a new emergency message is starting transmission in the present frame. Once all of the emergency messages of the stations of the frame are no longer active (e.g., expired), the system will generate a physical layer frame that comprises no emergency message. When generating a physical layer frame having no emergency message, the system sets the hits back to their default value 00 (e.g., clears the bits).

The next time an emergency alert becomes active, the state of the ea_wake_up_bits may be advanced, such that the bits value is 01. In this example, the value of the bits indicate that an emergency message is included in the physical layer frame because the value of the bits include at least one instance of a “1”. Further, the advancement (e.g., change) of the bits' value, as compared to the previous physical layer frame, indicates that a new emergency message is included in the frame. Once all the emergency alerts of the stations of the frame expire, the system sets the bits back to their default value 00 (e.g., clears the bits). This scheme may continually shift from the default state to the active state according to FIG. 5A.

FIG. 5B illustrates another example scheme for advancing (e.g., changing) the state of ea_wake_up_bits. In this example, a second emergency alert becomes active before the full duration of first emergency alert expires. Likewise, a third emergency alert becomes active before the full duration of second emergency alert expires. Said another way, multiple emergency alerts are active at the same time.

In this example, the first physical layer frame includes no emergency message, so the ea_wake_up_bits are set to the default setting of 00. When a physical layer frame is generated that will include an emergency message, the state of the ea_wake_up_bits may be advanced, such that the bits value is 01. The presence of any value other than 00 is an indication that an emergency message referencing an active emergency alert is included in the physical layer frame, so the bits value of 01, indicates as such. Further, a transition of the ea_wake_up_bits to any state that contains at least one instance of “1” indicates that there is at least one new emergency message starting delivery on this frame for a station of this frame.

In this example, a new emergency alert (e.g., the second emergency alert) becomes active before all of the previous emergency alerts expired so the system indicates that a new emergency message is starting delivery the physical layer frame by advancing the bits from 01 (the previous frame) to the value 10 (current frame). Any value other than 00 is an indication that an emergency alert is still active, so the bits value of 10, indicates the existence of an active emergency alert. Further, because the ea_wake_up_bits's value in the present physical layer frame is different from the ea_wake_up_bits's value of the previous physical layer frame, the present ea_wake_up_bits state indicates that a new emergency message is included in the present physical layer frame as compared to the previous physical layer frame.

Further, in this example, a third emergency alert goes active before expiration of previous emergency alerts. As shown in FIG. 5B, the system indicates that a new emergency message (e.g., the third emergency message) is included in a physical layer frame by advancing the bits to the value 11. Said another way, because the ea_wake_up_bits's value in the present physical layer frame includes a “1” and is different from the ea_wake_up_bits's value of the previous physical layer frame, the present ea_wake_up_bits state indicates that a new emergency message is starting delivery in the present physical layer frame. Further, because any value other than 00 is an indication that an active emergency alert exists, the bits value of 11, indicates the existence of an active emergency alert. Once the third emergency alert and all of the other emergency alerts are no longer active, the system sets the bits back to their default value 00 (e.g., clears the bits).

FIG. 5C illustrates an example scheme for advancing (e.g., changing) the state of ea_wake_up_bits when a fourth emergency alert goes active before expiration of all previous emergency alerts. In this example, the system advances the value of the bits to the value 01. Any value other than 00 is an indication that an active emergency alert exists, so the bits value of 01, indicates the presence of an active emergency alert. Further, because the ea_wake_up_bits's value in the present physical layer frame includes a “1” and is different from the ea_wake_up_bits's value of the previous physical layer frame, the present ea_wake_up_bits state indicates that a new emergency message is starting delivery in the present physical layer frame as compared to the previous physical layer frame. The system may continuously shift through the bits' non-zero values, as is desired to accommodate any and all queued emergency alerts. The system may clear the bits to their default state of 00 once all the emergency alerts of all the stations included in the frame expire. Of course, there are some circumstances wherein one or more emergency alerts are active but not expressed or otherwise identified in the ea_wake_up_bits. A station may decide Whether an alert should or should not be indicated in the ea_wake_up_bits.

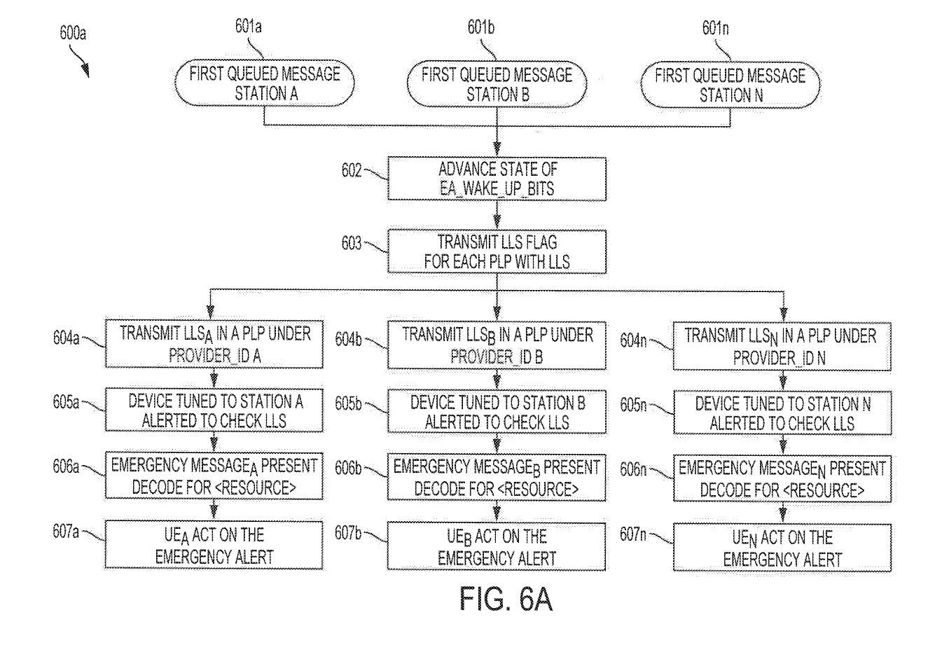

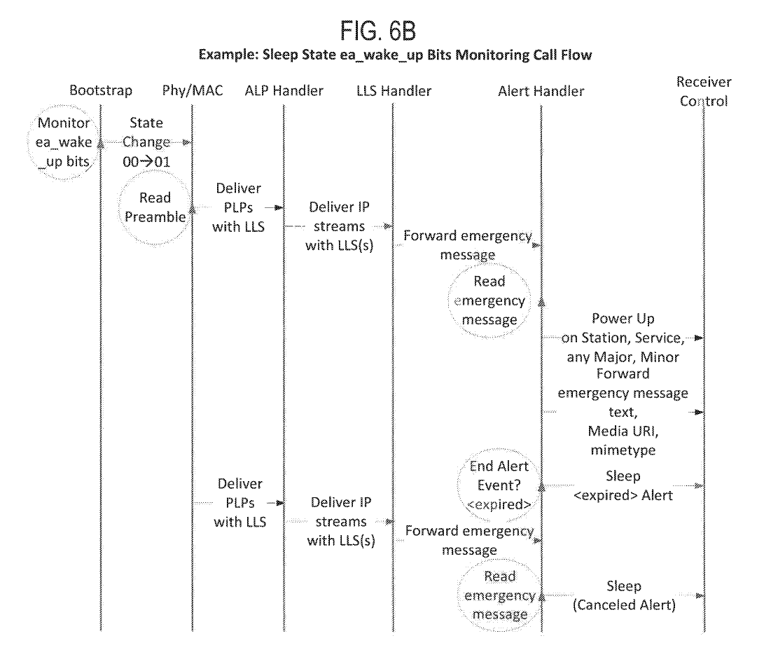

FIG. 6A illustrates an example method of transmitting and receiving a physical layer frame, wherein a plurality of stations are sending data on the physical layer frame, In example method 600a, one or more new emergency messages may be transmitted in a physical layer frame. In this example, the first queued emergency message of station A is identified at step 601a. In light of the presence of a queued emergency message, at step 602, the system determines that a new emergency message will be included in the present physical layer frame and based on the determination, advances the state of ea_wake_up_bits, to indicate that a new emergency message will be included in the physical layer frame, At step 603, which may occur before or after step 602, the system sets an LLS flag indicating which PLP includes the LLS comprising the new emergency message of station A, the identifier of station A, and the system generates the corresponding LLS_{A}.

In step 604a, the system transmits LLS_{A} in a PLP under Provider_ID A. In step 605a, a UE device checks the ea_wake_up_bits state and is alerted that a new emergency message is within the frame and checks the LLS_{A} for a new emergency message. In step 606a, the UE finds the applicable new emergency message in LLS_{A}. In step 607a, the UE acts on the new emergency message.

Likewise, in example method 600a, the first queued emergency message of station B is identified at step 601b. In this example, the system has already advanced the state of the ea_wake_up_bits for the current physical layer frame to indicate that a new emergency message will be included in the current physical layer frame. As such, since the ea_wake_up_bits state already indicates the presence of a new emergency message in the physical layer frame, step 602 may not advance the state of the ea_wake_up_bits in reaction to step 601b. At step 603, the system sets an LLS flag indicating which PLP includes the LLS comprising the new emergency message of station B and the identifier of station B, and the system generates the corresponding LLS_{B}.

In step 604b, the system transmits LLS_{B} in a PLP under Provider_ID B. In step 605b, a UE device checks the ea_wake_up_bits state and is alerted that a new emergency message is within the frame and checks the LLS₅ for a new emergency message. In step 606b, the UE finds the applicable new emergency message in LLS₅. In step 607b, the UE acts on the new emergency message.

Likewise, in example method 600a, the first queued emergency message of station N is identified at step 601n. In this example, the system has already advanced the state of the ea_wake_up_bits to indicate that a new emergency message will be included in the current physical layer frame. As such, since the ea_wake_up_bits state already indicates the presence of a new emergency message in the physical layer frame, step 603 may not advance the state of the ea_wake_up_bits in reaction to step 601n. At step 603, the system sets an LLS flag indicating which PLP includes the LLS comprising the emergency message of station N and the identifier of station N, and the system generates the corresponding LLS_{N}.

In step 604n, the system transmits LLS_{N} in a PLP under Provider_ID N. In step 605n, a UE device checks the ea_wake_up_bits state and is alerted that a new emergency message is within the frame and checks the LLS_{N} for a new emergency message. In step 606n, the UE finds the applicable new emergency message in LLS_{N}. In step 607n, the UE acts on the new emergency message. The various systems and devices of system 100 are operable to perform the steps of method 600a.

In embodiments, the UE may receive more than one new emergency message within the physical layer frame. In such a case, the UE may prioritize the new emergency messages and act on the emergency alerts in order of the corresponding emergency messages' priority. EAS messages are prioritized higher than non-EAS messages. In embodiments, an emergency message may indicate its priority level, and emergency messages having a higher priority level are prioritized higher than emergency messages having a comparatively lower priority level. If two or more emergency messages have the same priority level, the emergency messages may be queued in the order in which they were read by the UE (e.g., First-In-First-Out).

FIG. 6B illustrates an embodiment wherein a physical layer frame is limited to including only a single new emergency message. In such a case, the UE may avoid prioritizing new emergency alerts because the UE only receives a single new emergency alert in a given physical payer frame.

For example, in some circumstances more than one station may have a new emergency alert queued in its queue at the time that a new physical layer frame is being generated. In embodiments, rather than including multiple new emergency alerts (e.g., n alerts for n stations) within the physical layer frame being generated, the system may prioritize the emergency alerts at the network level and ensure that only one new emergency alert message is included in the physical layer frame when the physical layer frame is generated. In embodiments, EAS alerts are prioritized higher than non-EAS alerts. Further, an emergency alert may indicate its priority level, and emergency alerts having a higher priority level are prioritized higher than emergency alerts having a comparatively lower priority level. If two or more emergency alerts have the same priority level, the emergency alerts may be queued in the order in which they were received by the respective station (e.g., First-In-First-Out).

With the emergency alerts of the respective stations prioritized, a new emergency message is included within a physical layer frame according to its ordered priority. For example, the highest prioritized new emergency message is included in a first physical layer frame; the second highest prioritized new emergency message is included in a second physical layer frame; and the n^{th} highest prioritized new emergency message is included in an n^{th} physical layer frame; and so on and so on until all the queued emergency alerts are transmitted as emergency messages in serially transmitted frames,

Alternatively, rather than limiting a physical layer frame to include a single new emergency message, as is shown in FIG. 6B, embodiments may provide UEs with the ability to filter through multiple new emergency messages included in a physical layer frame such that the UE identifies which new emergency message of multiple new emergency messages is applicable to the UE. In such embodiments, one or more station may be assigned to a one or more class of multiple classes. For example, station A and station B may be assigned to class₁. In such an embodiment, all stations assigned to class₁ agree to service the same emergency alert and; or provide the same emergency message within a physical layer frame. Likewise, UEs may be assigned to one or more class of multiple classes. For example, UE_{A} and UE_{B} may be assigned to class₁. In embodiments, receivers may monitor for ea_wake_up_bits assigned to timeslots associated with their class, For example, UE_{A} and UE_{B} may monitor for ea_wake_up_bits assigned to timeslots associated with class₁. If an ea_wake_up_bits is assigned to a timeslot associated with class₁, then all UEs assigned to class₁ act on the emergency alert of the stations assigned to class₁. Likewise, if an ea_wake_up_bit is assigned to a timeslot associated with class₂, then all UEs assigned to class₂ act on the emergency alert of the stations assigned to class₂. Further still, if an ea_wake_up_bit is assigned to a timeslot associated with class_{N}, then all UEs assigned to class_{N} act on the emergency alert of the stations assigned to class_{N}. In this approach, a physical layer frame may comprise one or more emergency messages.

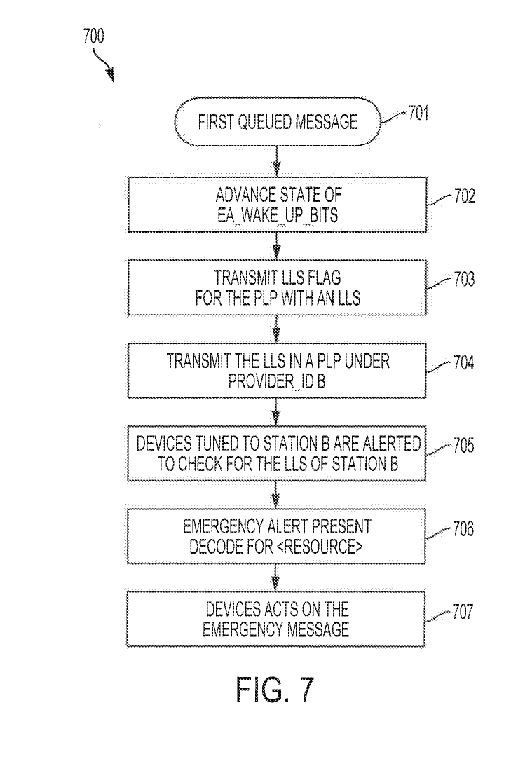

FIG. 7 illustrates an example method 700 of transmitting and receiving a physical layer frame, wherein only one station is transmitting data on the physical layer frame. In step 701, the system identifies a queued emergency message of the station, which indicates that the station has a new emergency message to transmit. In step 702, the system advances the state of the ea_wake_up_bits to indicate the physical layer frame will include the new emergency message. In step 703, the system generates the physical layer frame, which includes an LLS flag and the LLS, wherein the LLS includes the new emergency message and the station identifier. In step 704, the system transmits the physical layer frame. After the physical layer frame is transmitted, a UE (and/or its receiver) receives the physical layer frame and reads (e.g., decodes) the bootstrap (and/or system sync) having the ea_wake_up_bits. The state of the ea_wake_up_bits indicates that a new emergency message is included within the physical layer frame, so the UE is prompted to locate the new emergency message. In step 705, the UE knows from the LLS flag where to locate the LLS and decodes the LLS comprising the new emergency message. In step 706, the UE acts on the new emergency message by performing operations of the new emergency message. In this example, the new emergency message includes an emergency alert's location information (e.g., URI, URL, URN, pointer, and/or a link), and the UE uses the locating information to find the emergency alert referenced in the emergency message. The emergency message may also include an effective value and/or an expiration value. Having found the emergency alert, the UE may be instructed to render content on the UE for the user to perceive. The various systems and devices of system 100 are operable to perform the steps of method 700.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both non-transitory computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined. herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, which notifies one or more receiver of a new emergency alert, the method comprising:
determining whether at least one station of a set of stations has a new emergency message, wherein the set of stations comprises all stations that are sending data within a physical layer frame;
based on the determining, changing a state of bits, wherein the bits collectively indicate at least whether at least one station of the set of stations has a new emergency message, which will be included within the physical layer frame; and
including the bits within a bootstrap of the physical layer frame.

2. The method of claim 1, wherein the determining is based on at least one station of the set of stations having within its emergency alert queue the new emergency message.

3. The method of claim 2, wherein for each station of the at least one station having within its emergency alert queue a new emergency message, the method further comprises:
including, within the physical layer frame, the new emergency message of the respective station.

4. The method of claim 2 further comprising:
clearing the state of the bits upon expiration of all emergency messages of each of the stations of the set of stations,

5. The method of claim 1 wherein the state of the bits is changed only once per physical layer frame regardless of a number of stations including a respective new emergency message.

6. The method of claim 1 wherein the state of the bits indicates that none of the stations of the set of stations are associated with an active emergency alert.

7. The method of claim 1, wherein the method determines that two or more stations of the set of stations have a new emergency message, the method further comprising:
selecting a single new emergency message; and
including, within the physical layer frame, the selected new emergency message.

8. The method of claim 1, wherein the method determines that two or more stations of the set of stations have a new emergency message, the method further comprising:
including, within the physical layer frame, two or more new emergency messages that are respectively identified according to a classification of the station sending the respective new emergency message.

9. A system for notifying one or more receiver of a new emergency alert, the system comprising:
a network computer configured to determine whether at least one station of a set of stations has a new emergency message, wherein the set of stations comprises all stations that are sending data within a physical layer frame,
wherein the network computer is further configured to change a state of bits based on the determination, wherein the bits collectively indicate at least whether at least one station of the set of stations has a new emergency message, which will be included within the physical layer frame, and
wherein the network computer is further configured to include the bits within a bootstrap of the physical layer frame based on the determination; and
a transmitter configured to transmit the physical layer frame, wherein the physical layer frame includes the bootstrap.

10. The system of claim 9, wherein the determination is based on at least one station of the set of stations having within its emergency alert queue the new emergency message.

11. The system of claim 10, wherein for each station of the at least one station having within its emergency alert queue a new emergency message, the network computer is further configured to include, within the physical layer frame, the new emergency message of the respective station.

12. The system of claim 10, wherein the network computer is further configured to clear the state of the bits upon expiration of all emergency messages of each of the stations of the set of stations.

13. The system of claim 9 wherein the state of the bits is changed only once per physical layer frame regardless of a number of stations including a respective new emergency message.

14. The system of claim 9 wherein the state of the bits indicates that none of the stations of the set of stations are associated with an active emergency alert.

15. The system of claim 9, wherein the network computer is further configured to decide that two or more stations of the set of stations have a new emergency message, and the network computer is further configured to select a single new emergency message to include within the physical layer frame.

16. The system of claim 9, wherein the network computer is further configured to decide that two or more stations of the set of stations have a new emergency message, and the network computer is further configured to include, within the physical layer frame, two or more new emergency messages that are respectively identified according to a classification of the station. sending the respective new emergency message.

17. A system, which notifies one or more receiver of a new emergency alert, the system comprising:
means for determining whether at least one station of a set of stations has a new emergency message, wherein the set of stations comprises all stations that are sending data within a physical layer frame;
based on the determining, means for changing a state of bits, wherein the bits collectively indicate at least whether at least one station of the set of stations has a new emergency message, which will be included within the physical layer frame; and
means for including the bits within a bootstrap of the physical layer frame.

18. The system of claim 17, wherein the determining is based on at least one station of the set of stations having within its emergency alert queue the new emergency message.

19. The system of claim 18 further comprising:
means for clearing the state of the bits upon expiration of all emergency messages of each of the stations of the set of stations.

20. The system of claim 17 wherein the state of the bits is changed only once per physical layer frame regardless of a number of stations including a respective new emergency message.

21. The system of claim 17 wherein the state of the bits indicates that none of the stations of the set of stations are associated with an active emergency alert.

22. The system of claim 17, wherein the system determines that two or more stations of the set of stations have a new emergency message, the system further comprising:
means for selecting a single new emergency message; and
means for including, within the physical layer frame, the selected new emergency message,

23. The system of claim 17, wherein the system determines that two or more stations of the set of stations have a new emergency message, the system further comprising:
means for including, within the physical layer frame, two or more new emergency messages that are respectively identified according to a classification of the station sending the respective new emergency message.

24. A non-transitory computer-readable medium having program code recorded thereon, which notifies one or more receiver of a new emergency alert, the program code comprising:
program code for determining whether at least one station of a set of stations has a new emergency message, wherein the set of stations comprises all stations that are sending data within a physical layer frame;
based on the determining, program code for changing a state of bits, wherein the bits collectively indicate at least whether at least one station of the set of stations has a new emergency message, which will be included within the physical layer frame; and
program code for including the bits within a bootstrap of the physical layer frame.

25. The non-transitory computer-readable medium of claim 24, wherein the determining is based on at least one station of the set of stations having within its emergency alert queue the new emergency message,

26. The non-transitory computer-readable medium of claim 25, wherein for each station of the at least one station having within its emergency alert queue a new emergency message, the non-transitory computer-readable medium further comprising:
program code for including, within the physical layer frame, the new emergency message of the respective station.

27. The non-transitory computer-readable medium of claim 25 further comprising:
program code for clearing the state of the bits upon expiration of all emergency messages of each of the stations of the set of stations.

28. The non-transitory computer-readable medium of claim 24 wherein the state of the bits is changed only once per physical layer frame regardless of a number of stations including a respective new emergency message.

29. The non-transitory computer-readable medium of claim 24 wherein the state of the bits indicates that none of the stations of the set of stations are associated with an active emergency alert.

30. The non-transitory computer-readable medium of claim 24, wherein the program code determines that two or more stations of the set of stations has a new emergency message, the non-transitory computer-readable medium further comprising:
program code for selecting a single new emergency message; and
program code for including, within the physical layer frame, the selected new emergency message.
